(19) United States
(12) Patent Application Publication
(10) Pub. No.: US 2017/0017405 A1
(43) Pub. Date: Jan. 19, 2017

(54) SYSTEMS AND METHODS FOR IMPROVING FLASH-ORIENTED FILE SYSTEM GARBAGE COLLECTION

(71) Applicant: HGST Netherlands B.V., Amsterdam (NL)

(72) Inventors: Vyacheslav Anatolyevich DUBEYKO, San Jose, CA (US); Cyril GUYOT, San Jose, CA (US)

(73) Assignee: HGST Netherlands B.V., Amsterdam (NL)

(21) Appl. No.: 14/799,244

(22) Filed: Jul. 14, 2015

(51) Int. Cl. G06F 3/06

(52) U.S. Cl. CPC G06F 3/0608; G06F 3/0643; G06F 3/0652; G06F 3/0679

(57) ABSTRACT

Techniques for improving flash-oriented file system garbage collection are disclosed. In some embodiments, the techniques may be realized as a method for improving garbage collection of a flash-oriented file system comprising classifying data according to a first data type area of a plurality of data type areas, creating, using a host device subsystem, a log for a physical erase block of the flash memory, creating, using the host device subsystem, the plurality of data type areas for the log, and writing the data to the first data type area of the plurality of data type areas based on the classification of the data.

### BACKGROUND

In some systems associated with flash memory (e.g., file systems associated with NAND flash memory), once a page of flash memory is written, a system may be required to erase an entire Physical Erase Block (PEB) composed of multiple flash memory pages before the page of flash memory can be written to again. Because of this, file systems of flash memory may use a Copy-On-Write scheme for updates to information on flash memory storage. A Copy-On-Write scheme requires a garbage collector (GC) subsystem for clearing and re-using updated (invalid) Physical Erase Blocks and pages. Garbage Collection threads may degrade the performance of aged portions of a file systems associated with flash memory (e.g., due to locking and contention issues between a flash-oriented file system and a garbage collector subsystem, due to GC related write requests, and due to extra resources needed for GC threads). Garbage collection may also shorten a lifetime of some flash memory devices (e.g., due to extra program/erase cycles). Selecting a Physical Erase Block for efficient garbage collection is a very complex decision. Such selection (e.g., GC policy) will define efficiency of garbage collection and performance of a flash-oriented file system as a whole.

### SUMMARY

Techniques for improving flash-oriented file system garbage collection are disclosed. In some embodiments, the techniques may be realized as a method for improving garbage collection of a flash-oriented file system comprising classifying data according to a first data type area of a plurality of data type areas, creating, using a host device subsystem, a log for a physical erase block of the flash memory, creating, using the host device subsystem, the plurality of data type areas for the log, and writing the data to the first data type area of the plurality of data type areas based on the classification of the data.

In accordance with additional aspects of this embodiment, the plurality of data type areas may each based on an update frequency of data in a particular area, wherein the update frequency is based on at least one of how frequently data in the particular area has historically been updated and how frequently data in the particular area is projected to be updated.

In accordance with further aspects of this embodiment, the plurality of data type areas may each comprised of at least one of: a hot data type area, a warm data type area, and a cold data type area.

In accordance with other aspects of this embodiment, the cold data type area may be used for storing less frequently updated data.

In accordance with additional aspects of this embodiment, the hot data type area may be used for storing frequently updated data.

In accordance with further aspects of this embodiment, the warm data type area may be used for storing updates to the cold data type area.

In accordance with other aspects of this embodiment, the cold data type area may include large extents.

In accordance with additional aspects of this embodiment, the warm data type area may include small extents.

In accordance with further aspects of this embodiment, the log may be a fixed size log.

In accordance with other aspects of this embodiment, the log may include at least one of: a header and a footer.

In accordance with additional aspects of this embodiment, the techniques may include instantiating a garbage collection subsystem, identifying, using the garbage collection subsystem, a cold data type area of the plurality of data type areas, and reclaiming space of the cold data type area using the garbage collection subsystem.

In accordance with further aspects of this embodiment, the garbage collection may be performed on oldest data of the cold data type area first.

In accordance with other aspects of this embodiment, the techniques may be realized as a computer program product comprised of a series of instructions executable on a computer. The computer program product may perform a process for improving flash-oriented file system garbage collection. The computer program may implement the steps of: classifying data according to a first data type area of a plurality of data type areas, creating, using a host device subsystem, a log for a physical erase block of the flash memory, creating, using the host device subsystem, the plurality of data type areas for the log, and writing the data to the first data type area of the plurality of data type areas based on the classification of the data.

In another particular embodiment, the techniques may be realized as a system for improving flash-oriented file system garbage collection. The system may include a storage media device and a host device associated with the storage media device. The host device may be configured to classify data according to a first data type area of a plurality of data type areas, create a log for a physical erase block of the storage media device, create the plurality of data type areas for the log, and write the data to the first data type area of the plurality of data type areas based on the classification of the data.

In accordance with other aspects of this embodiment, the first data type area may be based on an update frequency of data in a particular area.

In accordance with further aspects of this embodiment, the plurality of data type areas may each include at least one of: a hot data type area, a warm data type area, and a cold data type area.

In accordance with additional aspects of this embodiment, the cold data type area may be used for storing less frequently updated data.

In accordance with other aspects of this embodiment, the hot data type area may be used for storing frequently updated data.

In accordance with additional aspects of this embodiment, the warm data type area may be used for storing updates to a cold data type area.

In accordance with further aspects of this embodiment, the cold data type area may include large extents.

The present disclosure will now be described in more detail with reference to exemplary embodiments thereof as shown in the accompanying drawings. While the present disclosure is described below with reference to exemplary embodiments, it should be understood that the present disclosure is not limited thereto. Those of ordinary skill in the art having access to the teachings herein will recognize additional implementations, modifications, and embodiments, as well as other fields of use, which are within the scope of the present disclosure as described herein, and with respect to which the present disclosure may be of significant utility.

### BRIEF DESCRIPTION OF THE DRAWINGS

In order to facilitate a fuller understanding of the present disclosure, reference is now made to the accompanying drawings, in which like elements are referenced with like numerals. These drawings should not be construed as limiting the present disclosure, but are intended to be exemplary only.

FIG. 1 is an exemplary block diagram depicting a host device, in accordance with an embodiment of the present disclosure.

FIG. 2 depicts a module for improving flash-oriented file system garbage collection, in accordance with an embodiment of the present disclosure.

FIG. 3 depicts a flowchart illustrating a method for creating a log from a plurality of data areas, in accordance with an embodiment of the present disclosure.

FIG. 4 depicts a flowchart illustrating a method for improving flash-oriented file system garbage collection, in accordance with an embodiment of the present disclosure.

FIG. 5 depicts a segment in flash memory including a plurality of Physical Erase Blocks (PEB), in accordance with an embodiment of the present disclosure.

FIG. 6 depicts a PEB including a plurality of logs, each log including a plurality of data type areas, in accordance with an embodiment of the disclosure.

FIG. 7 depicts a filling rate of a plurality of different areas of a log, in accordance with an embodiment of the disclosure.

FIG. 8 depicts potential uses of different data type areas, in accordance with an embodiment of the disclosure.

FIG. 9 depicts a fill pattern of different data type areas of different logs within a PEB, in accordance with an embodiment of the disclosure.

FIG. 10 depicts a migration of different data type areas of different logs between PEBs, in accordance with an embodiment of the disclosure.

FIG. 11 depicts a hot data type area used by a database table, in accordance with an embodiment of the disclosure.

FIG. 12 depicts a warm data type area used by word processor data and metadata, in accordance with an embodiment of the disclosure.

FIG. 13 depicts updates to a hot data type area, in accordance with an embodiment of the disclosure.

FIG. 14 depicts mixed hot and cold data type areas, in accordance with an embodiment of the disclosure.

### DESCRIPTION

The present disclosure relates to techniques for improving efficiency of garbage collection of flash-oriented file systems. According to some embodiments, garbage collection efficiency may be improved by using a stack model within a physical erase block to categorize and group data by data “temperature” (e.g., a frequency of updates) or other characteristics. Grouping data by temperature may allow identification of self-cleaning logical blocks (e.g., logical blocks or pages that are likely to be written over by file system Input/Output (I/O)). Identification of self-cleaning logical blocks or pages may allow garbage collection to be directed towards logical blocks or pages, which are not self-cleaning Identification of logical blocks or pages, which are less likely to receive I/O, may allow garbage collection to be performed with less impact on file system processes.

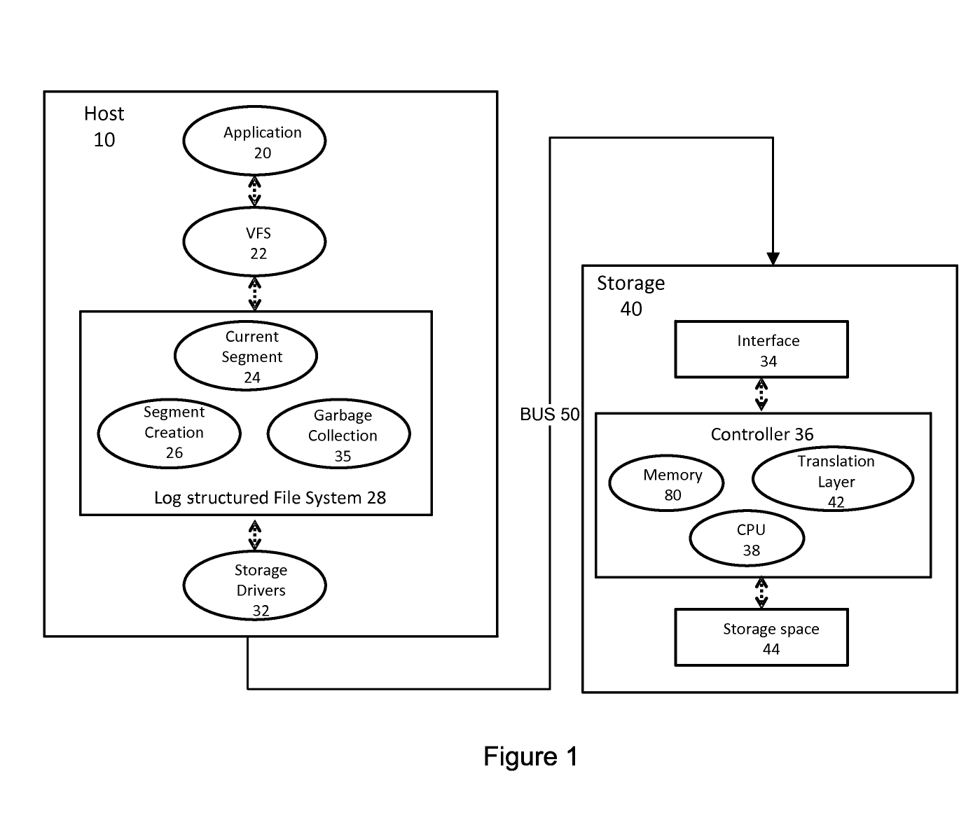

Turning now to the drawings, FIG. 1 is an exemplary block diagram depicting a host device, in accordance with an embodiment of the present disclosure. FIG. 1 includes a number of computing technologies such as a host 10, application 20, virtual file system (VFS) 22, a log structured file system 28, storage drivers 32, a bus 50, storage 40, an interface 34, controller 36, and storage space 44. As illustrated, a controller 36 may contain one or more components such as, for example, a memory 80, a translation layer 42 (e.g., used to provide a mapping of logical blocks into physical pages), and a CPU (Central Processing Unit) 38. As illustrated, a log-structured file system 28 may contain one or more components such as, for example, a current segment 24, a segment creation 26, and a garbage collection 35. In some embodiments, current segment 24 may be a subsystem that collects memory pages of files that are created or updated by a user. In some embodiments, current segment 24 may keep memory pages until the moment of flushing the pages onto a volume (e.g., log creation). Current segment 24 may classify memory pages and/or keep different types of memory pages in different data areas. In one or more embodiments, segment creation 26 may be a subsystem that gets memory pages from current segment 24 and merges several data areas into one log. Segment creation 26 may process write a created log on a volume (e.g., flush the log).

As used herein, the phrase “in communication with” means in direct communication with or in indirect communication with via one or more components named or unnamed herein (e.g., a memory card reader). The host 10 and the storage 40 can be in communication with each other via a wired or wireless connection and may be local to or remote from one another or even combined. In some embodiments, host 10 may use storage drivers 32 communicate across bus 50 with storage 40 via an interface 34. Storage drivers 32 may use one or more interface standards (e.g., Small Computer Systems Interface (SCSI), Serial ATA (SATA), etc.) or may be proprietary. Interface 34 may provide access to controller 36 (e.g., a Solid State Device (SSD) controller). Virtual file system (VFS) 22 may be an abstraction layer on top of a traditional file system, which may allow client applications to access different types of traditional file systems in a uniform way. Log-structured file system 28 may provide a file system which sequentially writes data and metadata to a circular log (e.g., a buffer).

The host 10 can take any suitable form, such as, but not limited to, an enterprise server, a database host, a workstation, a personal computer, a mobile phone, a game device, a personal digital assistant (PDA), an email/text messaging device, a digital camera, a digital media (e.g., MP3) player, a GPS navigation device, and a TV system. The storage 40 can also take any suitable form, such as, but not limited to, a universal serial bus (USB) device, a memory card (e.g., an SD card), a hard disk drive (HDD), a solid state device (SSD), and a redundant array of independent disks (RAID). Also, instead of the host device 10 and the storage 40 being separately housed from each other, such as when the host 10 is an enterprise server and the storage 40 is an external card, the host 10 and the storage 40 can be contained in the same housing, such as when the host 10 is a notebook computer and the storage 40 is a hard disk drive (HDD) or solid-state device (SSD) internal to the housing of the computer.

The memory 80 can take any suitable form, such as, but not limited to, a solid-state memory (e.g., DRAM or SRAM).

The host 10 and the storage 40 can include additional components, which are not shown in FIG. 1. Also, in some embodiments, not all of the components shown are present. Further, the various controllers, blocks, and interfaces can be implemented in any suitable fashion. For example, a controller can take the form of one or more of a microprocessor or processor and a computer-readable medium that stores computer-readable program code (e.g., software or firmware) executable by the (micro)processor, logic gates, switches, an application specific integrated circuit (ASIC), a programmable logic controller, and an embedded microcontroller, for example. For example, controller 36 can be implemented as an ASIC or as combination of CPU, memory (e.g., DRAM), and one or more circuits that implement Flash Translation Layer (FTL) logic.

Storage 40 and storage space 44 may utilize one or more storage technologies such as, for example, SSD storage (e.g., NAND flash memory based storage).

Garbage collection 35 may improve efficiency by using a stack model within a physical erase block to categorize and group data by data “temperature” (e.g., a frequency of updates) or other characteristics when data is written to the physical erase block. Grouping data by temperature may allow identification of self-cleaning logical blocks (e.g., logical blocks or pages that are likely to be written over by file system Input/Output (I/O)). Identification of self-cleaning logical blocks or pages may allow garbage collection to be directed towards logical blocks or pages which are not self-cleaning Identification of logical blocks or pages which are less likely to receive I/O may allow garbage collection to be performed with less impact on file system processes.

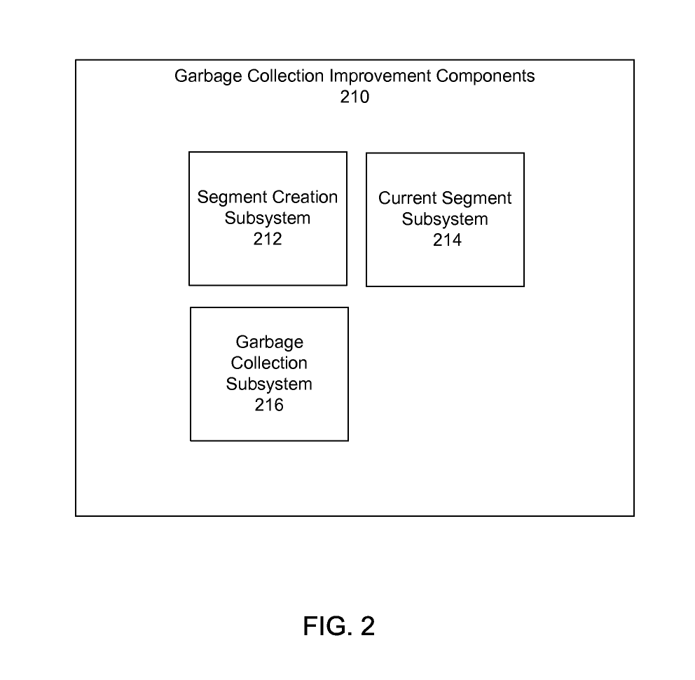

FIG. 2 depicts a module for improving flash-oriented file system garbage collection, in accordance with an embodiment of the present disclosure. Components may be hardware (e.g., dedicated circuitry), firmware, software, or a combination of the foregoing.

The description below describes network elements, computers, and/or components of a system and method for backup and restoration that may include one or more components. As used herein, the term “component” may be understood to refer to computing software, firmware, hardware, and/or various combinations thereof. Components, however, are not to be interpreted as software which is not implemented on hardware, firmware, or recorded on a processor readable recordable storage medium (components are not software per se). It is noted that the components are exemplary. The components may be combined, integrated, separated, and/or duplicated to support various applications. Also, a function described herein as being performed at a particular component may be performed at one or more other components and/or by one or more other devices instead of or in addition to the function performed at the particular component. Further, the components may be implemented across multiple devices and/or other components local or remote to one another. Additionally, the components may be moved from one device and added to another device, and/or may be included in both devices. In some embodiments, one or more components may be implemented as part of SSD Controller, a host system, and/or SSD optimization software. As illustrated in FIG. 2, garbage collection improvement components 210 may contain segment creation subsystem 212, Current Segment Subsystem 214, and garbage collection component 216.

Segment creation subsystem 212 may generate one or more logs within a Physical Erase Block (PEB). According to some embodiments, logs may be of a fixed size. A log may contain metadata information (e.g., to indicate a position of a transaction in a log in a file system's chain of logs and to verify this chain). In some embodiments a log may contain a header and/or a footer. A header may identify the beginning of the log and to describe main characteristics of the log. A footer may be a metadata item identifying the end of the log and can contain a specific metadata information known at the end of a log creation. A log may also contain space for a user data payload.

Current Segment Subsystem 214 may organize and/or create one or more data type areas within a log. According to some embodiments, a data type area may be a portion of a log for a specific type of data (e.g., data grouped according to update frequency, last update time, estimated update frequency, estimated update time, or another indication of how likely data is to be modified within a time period.)

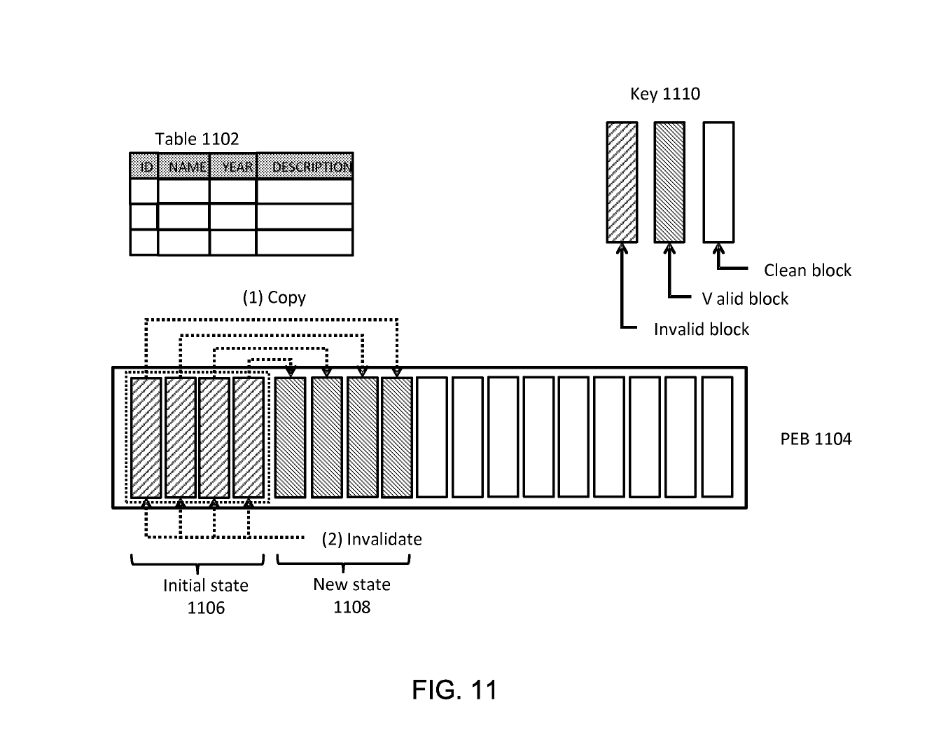

In some embodiments, Current Segment Subsystem 214 may identify a data type area of “hot,” which may be data that is expected to be modified frequently. A hot data type area should contain frequently updated extents of a small size. For example, a hot file may be a small temporary file that is created and used for a lot of read write operations during the life of a process. A temporary file may be deleted after the end of a process. This may result in significant portion or even an entire PEB being invalid after a temporary file is deleted. Another possible example of hot updates may be a database workload. As illustrated in FIG. 11, a hot data type area may be used by a database table (e.g., table 1102). For example, a database may need to update all rows of some column in a table (e.g., UPDATE Table 1102 SET Description=“Active” WHERE Year==2014). If table is located in several volume's logical blocks or pages and the requested column is distributed between all of these logical blocks then it needs to update all logical blocks. As illustrated, a single update may invalidate logical blocks of an initial state 1106 and write new logical blocks represented in a new state 1108. (See Key 1110 illustrating block states of Clean, Valid, and Invalid). If the entire table resides inside a dedicated PEB (e.g., PEB 1104) then, after continuous update operations, such a PEB may be completely invalid.

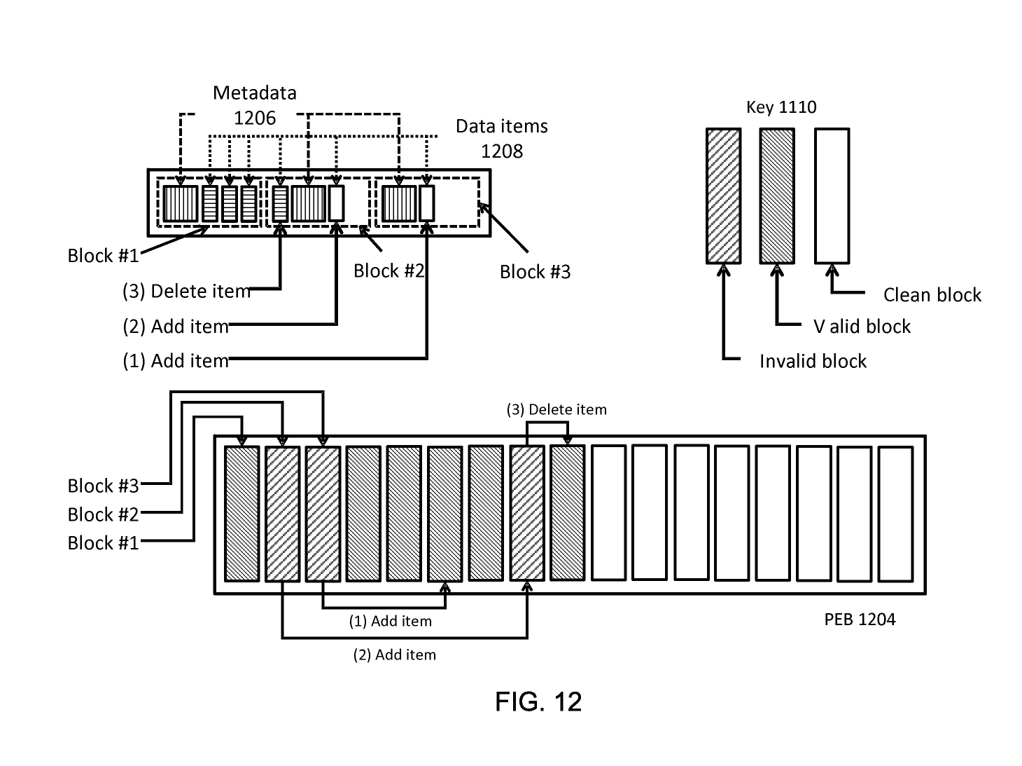

A data type area of “cold” may be identified or created by Current Segment Subsystem 214 for data that is not expected to be modified frequently. Cold data type areas may contain big size extents of rarely updated data. In some embodiments, a data type area of “warm” may be created to store one or more updates associated with data in a “cold” data type area. In some embodiments, a log may be created with a first data type area of “cold,” a second data type area of “warm,” and a third data type area of “hot,” however any combination of one or more data type areas may be used. For example, a log may be created with only a hot data type area, only a cold data type area, a cold data type area and a warm data type area, etc. The number of data type areas in a log, the type of data type areas in a log, and the size of each data type area in a log may depend on the nature of data being written to flash memory or to a particular PEB of flash memory. The data type areas in a particular log may not be a uniform size. For example, if a large amount of data is not expected to be updated, a particular log may have a large cold data type area, a small warm data type area, and little or no space reserved as a hot data type area. Data type areas of other types may be used. For example, in some embodiments, data may be grouped by application type, owner, a projected expiration date, etc. As illustrated in FIG. 12, a warm update area may be used, for example, by a document processor file. Data files of modern applications may have very complex structures. It is possible to compare such structure with file systems' structures. A data file (e.g., the data file stored in PEB 1204) may contain sophisticated metadata structures with encapsulated user data items. As a result, modification of such files may result in complex workloads. Metadata items (e.g., metadata 1206) of data files can be updated more frequently that user data items (e.g., data items 1208). As a result, logical blocks or pages that contain metadata items may be updated more frequently than others. Such files can be represented as a sequence of “cold” logical blocks with the inclusion of areas with “warm” logical blocks that can be updated from time to time.

Current Segment Subsystem 214 may also classify data according to a data type. In some embodiments, a classification (e.g., assigned to, or otherwise associated with said data) may be based upon historical or projected data updates, data types, applications associated with data, threads associated with data, owners associated with data or other factors.

Garbage collection subsystem 216 may reclaim space in a cold data type area (e.g., of a full PEB). In some embodiments, data in a oldest PEB or a most aged PEB may be cleaned first (e.g., based on a creation timestamp associated with a PEB). Other schemes or orders may be used. In some embodiments, data from a cold data type area may be written to a cold data type area in a different log (e.g., from an aged PEB to a clean PEB). A garbage collection subsystem may combine data from a warm data type area together in memory with the cold data prior to writing the cold data of an aged PEB to a new cold data type area (e.g., in a different log of a clean PEB).

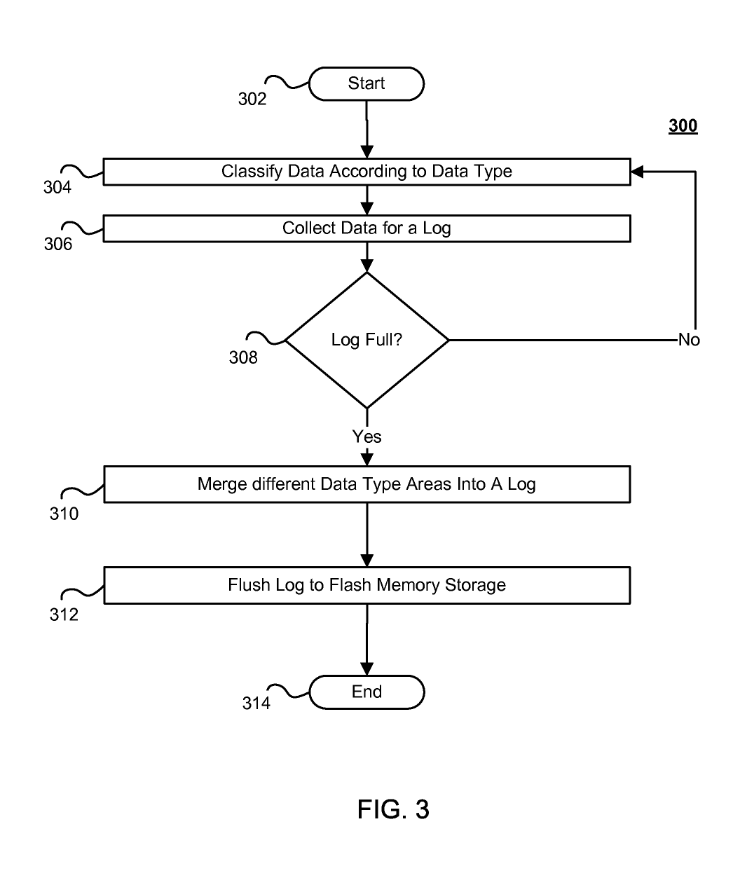

FIG. 3 depicts a flowchart illustrating a method for creating a log from a plurality of data areas, in accordance with an embodiment of the present disclosure. The process 300, however, is exemplary only. The process 300 can be altered, for example, by having stages added, changed, removed, rearranged, or any suitable combination thereof. At stage 302, the process may begin.

At stage 304, data may be classified by a data type. In some embodiments, classification may be based upon historical or projected data updates, data types, applications associated with data, threads associated with data, owners associated with data or other factors or combination of factors. According to some embodiments, a data type area may be a portion of a log for a specific type of data (e.g., data grouped according to update frequency, last update time, estimated update frequency, estimated update time, or another indication of how likely data is to be modified within a time period). In some embodiments, a data type area of “hot” may be identified or created in a log for data that is expected to be modified frequently. A hot data type area may contain frequently updated extents of a small size. A data type area of “cold” may be identified or created for data that is not expected to be modified frequently. Cold data type areas may contain big size extents of rarely updated data. In some embodiments, a data type area of “warm” may be created to store one or more updates associated with data in a “cold” data type area. In some embodiments, a log may be created with a first data type area of “cold,” a second data type area of “warm,” and a third data type area of “hot,” however any combination of one or more data type areas may be used. For example, a log may be created with only a hot data type area, only a cold data type area, a cold data type area and a warm data type area, etc. The number of data type areas in a log, the type of data type areas in a log, and the size of each data type area in a log may depend on the nature of data being written to flash memory or to a particular PEB of flash memory. The data type areas in a particular log may not be a uniform size. For example, if a large amount of data is not expected to be updated, a particular log may have a large cold data type area, a small warm data type area, and little or no space reserved as a hot data type area. Data type areas of other types may be used. For example, in some embodiments, data may be grouped by application type, owner, a projected expiration date, etc.

At stage 306, data for a log may be collected (e.g., saved into a specialized memory space prior to writing into logs). In some embodiments, a fixed number of logs may be used. A PEB may be visualized as sequence of logs. In some embodiments, a log may be a smallest transaction that changes file system's state. In some embodiments, a log may be a fixed size or length. A log may contain metadata information (e.g., to indicate a position of a transaction in a log in a file system's chain of logs and to verify this chain). In some embodiments a log may contain a header and/or a footer. A header may identify the beginning of the log and to describe main characteristics of the log. A footer may be a metadata item identifying the end of the log and can contain a specific metadata information known at the end of a log creation. A log may also contain space for a user data payload.

At stage 308, it may be determined if a log is full. If the log is full, the method may continue at stage 310. If the log is not full, the method may return to stage 304.

At stage 310, different data type areas may be merged into one log. At stage 312, the log may be flushed from memory to flash memory storage. Flushing may involve writing a log created in memory (e.g., DRAM) to flash memory. The method may end at stage 314.

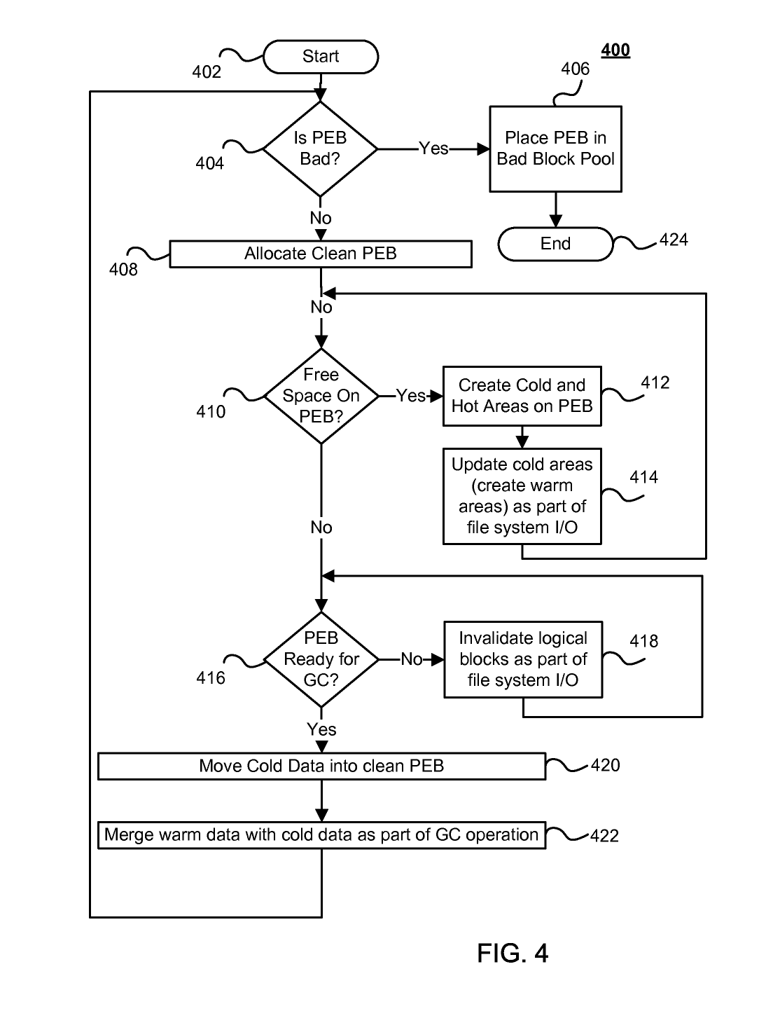

FIG. 4 depicts a flowchart illustrating a method for improving flash-oriented file system garbage collection, in accordance with an embodiment of the present disclosure. The process 400, however, is exemplary only. The process 400 can be altered, e.g., by having stages added, changed, removed, or rearranged. At stage 402, the process may begin.

At stage 404, it may be determined whether a PEB is bad. If a PEB has program/erase errors and/or read errors, it may be determined to be bad. In some embodiments, the determination may be based on a threshold (e.g., if errors exceed a certain number or a certain number within a specified time period, a threshold may be met). A threshold may also depend on a type of error encountered. If a PEB is determined to be bad, the method may continue at stage 406. If the PEB is determined to be good the method may continue at stage 408.

At stage 406, a bad PEB may be placed in a bad block pool. After a bad PEB is placed in the bad block pool the method may end at stage 424.

At stage 408, the clean PEB may be allocated.

At stage 410, it may be determined whether a PEB has free space. If a PEB has free space the method may continue at stage 412. If a PEB does not have free space, the method may continue at 416.

At stage 412, cold data type areas and hot data type areas may be created on the PEB. At stage 414, cold data type areas may be updated by creating warm areas as part of file system I/O.

At stage 416, it may be determined whether a PEB is ready for garbage collection (GC). A determination may be based in part on an amount of valid data remaining in a PEB, a “temperature” of one or more portions of data on a PEB or on other factors. Factors may include, for example, historical or projected data updates of remaining valid data, applications associated with remaining valid data, threads associated with remaining valid data, and/or owners associated with remaining valid data. If a PEB is ready for garbage collection, the method may continue at stage 420. If a PEB is not ready for garbage collection, the method may continue at stage 418.

At stage 418, logical blocks may be invalidated as part of file system I/O processes and garbage collection may be deferred.

At stage 420, cold data may be moved into a clean PEB. At stage 422, warm data may be merged with cold data as part of a garbage collection operation (e.g., cold data and warm data may be merged in memory and then written to a clean PEB).

After valid data is moved from a PEB the PEB may be erased. Any errors encountered during a program/erase cycle may be a factor in the determination at stage 404 (e.g., if errors are encountered erasing the PEB it may be determined to be a bad PEB, otherwise it may be allocated).

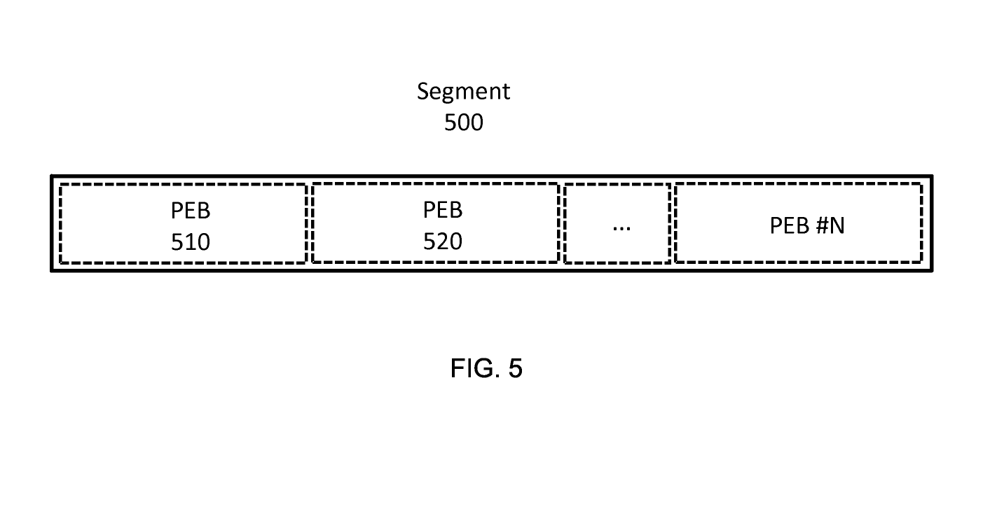

FIG. 5 depicts a segment in flash memory including a plurality of PEB, in accordance with an embodiment of the present disclosure. As depicted in FIG. 5, segment 500 may contain one or more PEBs. For example, segment 500 may contain PEB 510, PEB 520, through PEB N. The PEBs may be of a fixed size which may depend on a manufacturer specified size.

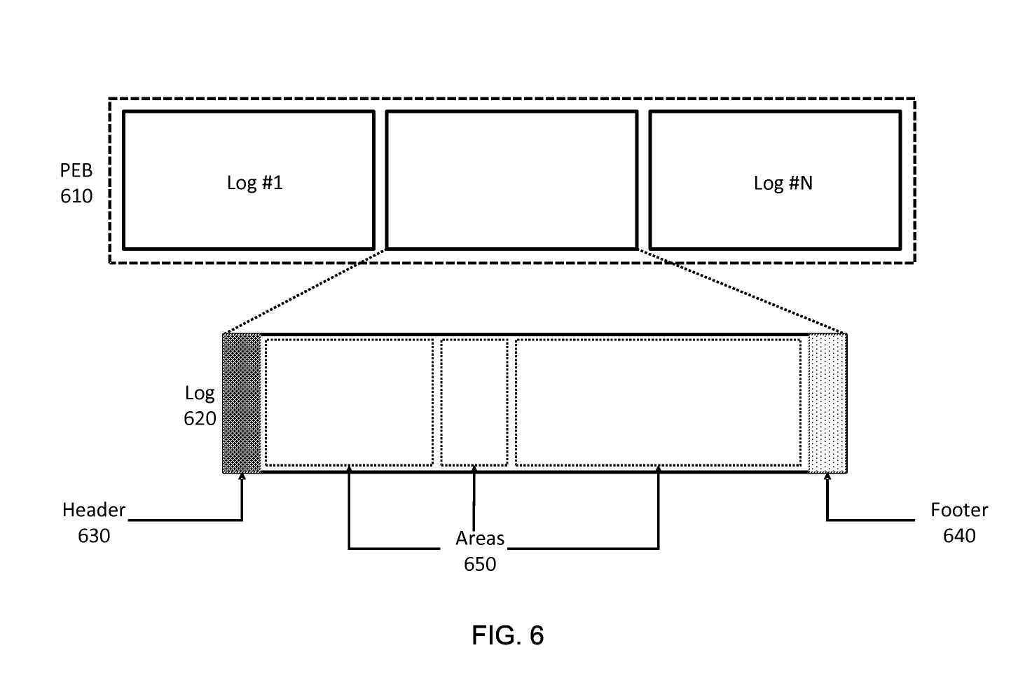

FIG. 6 depicts a PEB 610 including a plurality of logs (e.g., log #1, . . . , log #N), each log including a plurality of data type areas, in accordance with an embodiment of the disclosure. As illustrated, log 620 may include a header 630, a footer 640, and one or more data type areas 650. In some embodiments, flash-oriented file systems may use a Copy-on-Write (COW) policy for filling PEB by data because of a nature of write operations. A COW policy may mean that every updated logical block should be copied in a new place. As a result, a PEB may be written in sequential manner. The amount of I/O requests for one flush of a PEB can be smaller than a PEB's size. Every PEB can be imagined as a sequence of logs. A log may be a smallest transaction that changes file system's state. A log may contain metadata information indicating a position of a transaction represented by a log in a file system's chain of logs. A log may also allow for verification of such a chain. A log's header may identify the beginning of the log and to describe main characteristics of the log. A log's footer may be a metadata item to identify the end of the log and may contain a specific metadata information are known at the end of a log creation.

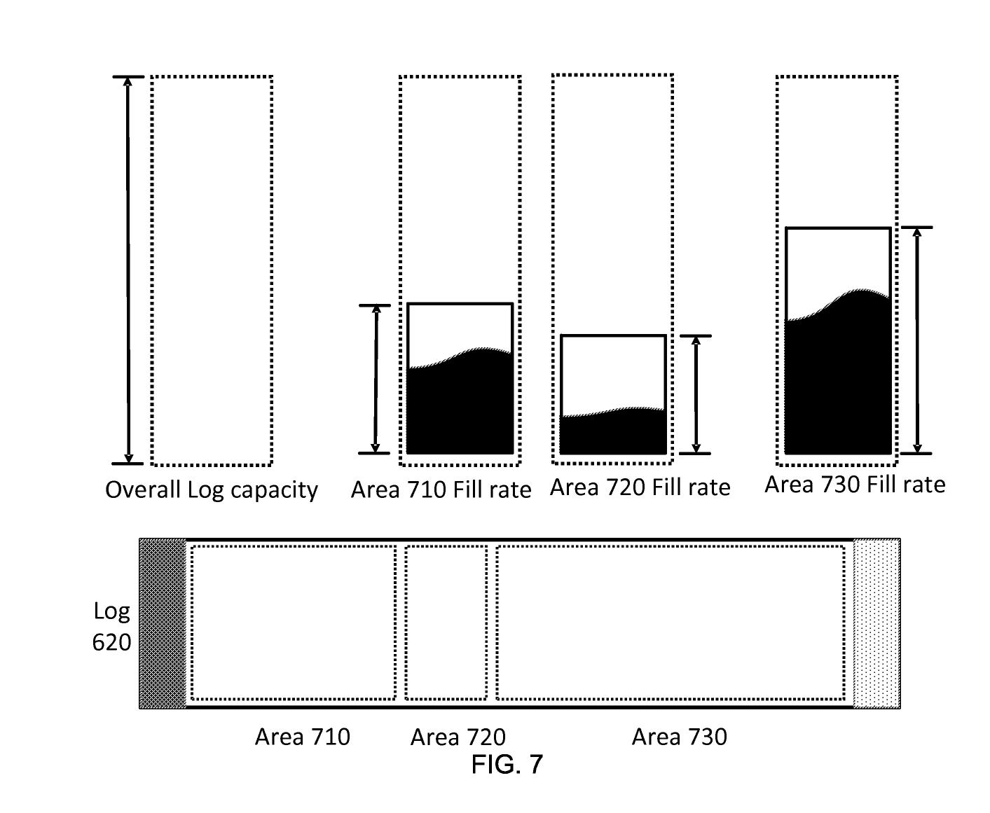

FIG. 7 depicts a filling rate of a plurality of different areas of a log in accordance with an embodiment of the disclosure. As depicted in FIG. 7, log 620 may contain a plurality of different data type areas (e.g., areas 710, 720, and 730). Different data type areas may fill at different rates (e.g., fill rates 710, 720, and 730). Flash memory devices may have a limited number of program/erase cycles that a PEB can support. Wear leveling may attempt to balance out the program/erase cycles so that flash memory life can be prolonged. By focusing garbage collection on cold areas and allowing file system I/O to clean hot areas, an amount of garbage collection activity may be reduced. Cleaning hot areas of a PEB may occur as part of file system I/O when valid data in the PEB is updated which results in the new data (i.e., the data of the update) being written to a new PEB and the old data of the first PEB being invalidated. By allowing valid pages in hot areas to be moved to a different PEB as part of file system I/O garbage collection may be reduced.

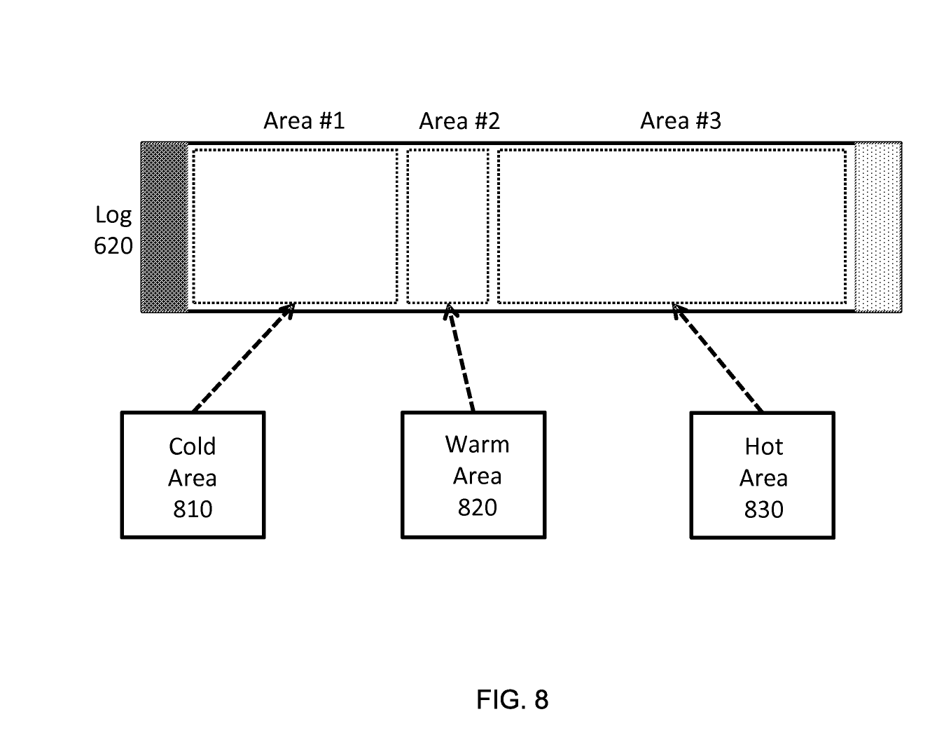

FIG. 8 depicts potential uses of different data type areas in accordance with an embodiment of the disclosure. According to some embodiments, one of the possible schemes of data distribution is a set of cold, warm, and hot areas (e.g., cold area 810, warm area 820, and hot area 830 in log 620). Specifically, a payload of a PEB's logs can be assembled from areas with cold, warm, and hot data. Cold data type area 810 may contain big size extents of rarely updated data. In some embodiments, data in cold data type areas may not be re-written. Logical blocks or pages in cold areas may be written only once and, then, possible updates of such data may be written in other areas (for example, in warm data type area 820). Warm data type area 820 can contain rarely updated data. Hot data type area 830 may contain frequently updated extents of data of small size.

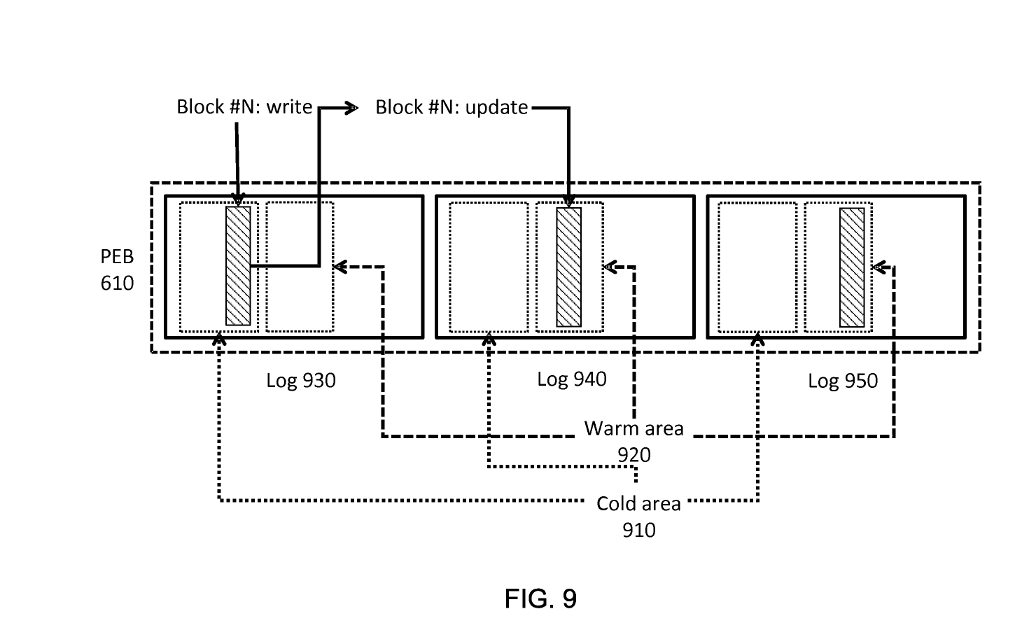

FIG. 9 depicts a fill pattern of different data type areas of different logs within a physical erase block in accordance with an embodiment of the disclosure. As illustrated, PEB 610 may contain a plurality of logs (e.g., logs 930, 940, and 950) and each log may have a cold area 910 and a warm area 920. If an update comes in for Block #N in a cold area 910 of Log 930, the update may be written to a warm area 920 (e.g., warm area 920 of log 940). As a result, no updates may occur to a cold area.

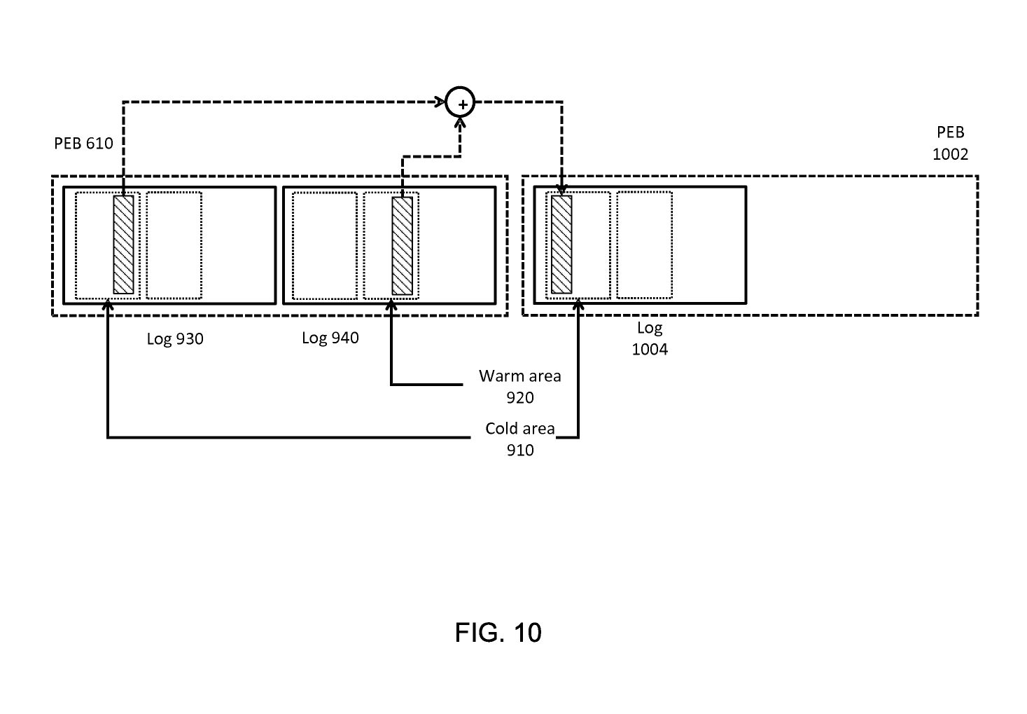

FIG. 10 depicts a migration of different data type areas of different logs (e.g., logs 930, 940, and 1004) between physical erase blocks in accordance with an embodiment of the disclosure. As depicted in FIG. 10, valid data from cold area 910 of log 930 of PEB 610 may be moved to cold area 910 of log 1004 of PEB 1002. For example, a garbage collection thread or subsystem may copy pages from PEB 610 into memory (e.g., DRAM), to prepare a new log and, then may write a log from memory into PEB 1002. This data may be combined, prior to writing to PEB 1002, with updates to cold area 910 of PEB 610 which were stored in warm area 920 of log 2 of PEB 610. Thus, reclaiming the space of cold area 910 of log 1 of PEB 610 may also reclaim space of warm area 920 of log 2 of PEB 610. Thus a migration scheme of a cold area may imply merging main block in cold area with updates in one or more warm areas during moving.

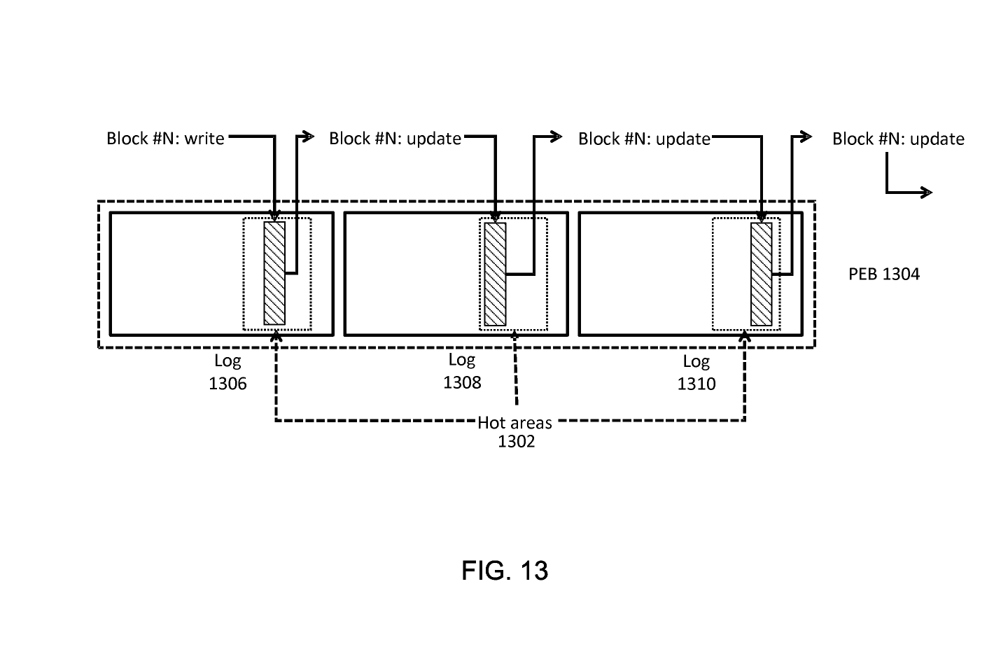

FIG. 13 depicts updates to a hot data type area, in accordance with an embodiment of the disclosure. As illustrated in FIG. 13, logs 1306, 1308 and 1310 of PEB 1304 may each contain a hot data type area of hot areas 1302. As illustrated, if small size extents of frequently updated data are localized in one area (e.g., a hot data type area) then a Copy-on-Write policy of data updates may invalidate blocks of a hot data type area in efficient manner without intervention by a garbage collection subsystem. Specifically, a necessity to update some blocks in a hot data type area implies copying the new version of this block into another PEB's log (e.g., from log 1310 off of PEB 1304). Frequent updates of data in a hot data type area may result in fast invalidation of blocks in the hot data type area. As a result, blocks of hot data type area may migrate from one hot data type area into another one because of update requests and these hot data type areas may be “cleared” by “natural” file system operations without necessity to copy such blocks via GC activity. Generally, Garbage Collection (GC) may not be used for clearing valid data blocks of hot data type areas—instead it may be preferable to wait while file system operations move data blocks from a PEBs hot area. In some embodiments, GC may be used for clearing valid blocks from a hot data type area in the case when erasure of a PEB is needed and some logs still contain valid blocks in hot areas.

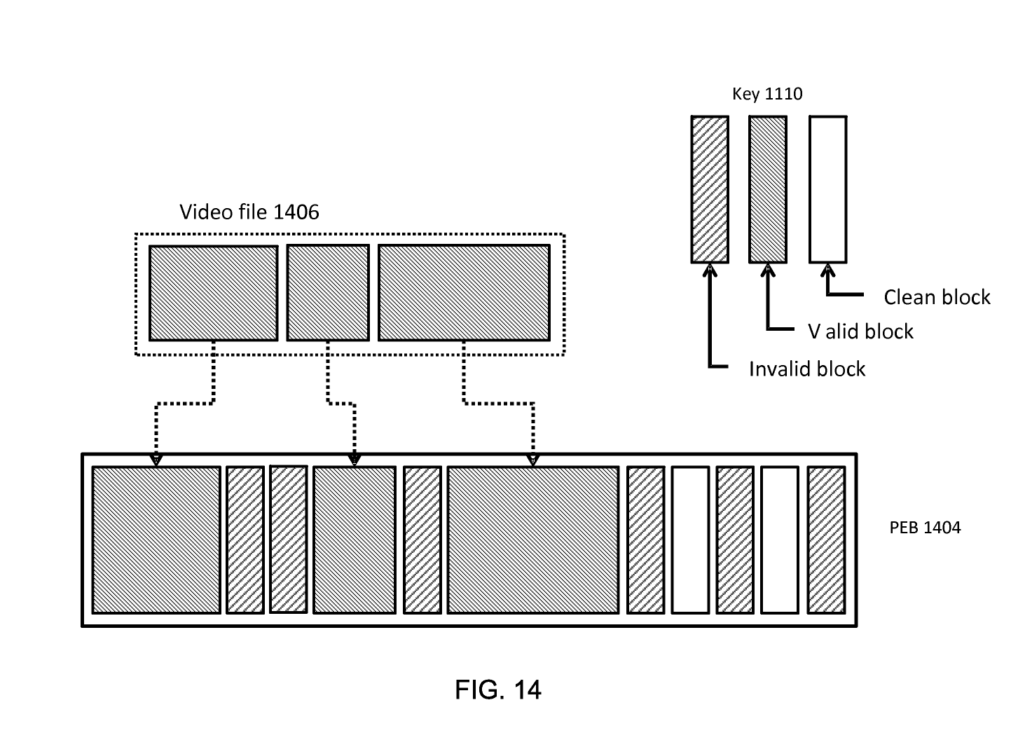

FIG. 14 depicts mixed hot and cold data type areas, in accordance with an embodiment of the disclosure. “Cold” and “hot” data may be mixed quite frequently in real workloads of multi-threaded applications. As a result, it may significantly complicate garbage collection operations and degrade the whole file system performance on aged volumes. For example, if two (or several) threads operate with data of different natures then, a mixed data type GC issue may occur. If one thread saves on PEB 1404, video file 1406, and another thread uses temporary files simultaneously on PEB 1404 (resulting in many invalid blocks), then, such a mixed use-case takes place. This may result in a need to: (1) copy significant amount of “cold” data during GC operation, (2) select a target PEB for efficient garbage collection, and/or (3) have metadata information for differentiation of valid and invalid blocks. The stack model for a PEB (as described above with respect to FIG. 6) may address these challenges.

Other embodiments are within the scope and spirit of the invention. For example, the functionality described above can be implemented using software, hardware, firmware, hardwiring, or combinations of any of these. One or more computer processors operating in accordance with instructions may implement the functions associated with for improving flash-oriented file system garbage collection in accordance with the present disclosure as described above. If such is the case, it is within the scope of the present disclosure that such instructions may be stored on one or more non-transitory processor readable storage media (e.g., a magnetic disk or other storage medium). Additionally, modules implementing functions may also be physically located at various positions, including being distributed such that portions of functions are implemented at different physical locations.

The present disclosure is not to be limited in scope by the specific embodiments described herein. Indeed, other various embodiments of and modifications to the present disclosure, in addition to those described herein, will be apparent to those of ordinary skill in the art from the foregoing description and accompanying drawings. Thus, such other embodiments and modifications are intended to fall within the scope of the present disclosure. Further, although the present disclosure has been described herein in the context of a particular implementation in a particular environment for a particular purpose, those of ordinary skill in the art will recognize that its usefulness is not limited thereto and that the present disclosure may be beneficially implemented in any number of environments for any number of purposes. Accordingly, the claims set forth below should be construed in view of the full breadth and spirit of the present disclosure as described herein.

What is claimed is:

1. A method for improving garbage collection of a flash-oriented file system comprising:
classifying data according to a first data type area of a plurality of data type areas;
creating, using a host device subsystem, a log for a physical erase block of the flash memory;
creating, using the host device subsystem, the plurality of data type areas for the log; and
writing the data to the first data type area of the plurality of data type areas based on the classification of the data.

2. The method of claim 1, wherein each of the plurality of data type areas is based on an update frequency of data in a particular area, wherein the update frequency is based on at least one of how frequently data in the particular area has historically been updated and how frequently data in the particular area is projected to be updated.

3. The method of claim 2, wherein each of the plurality of data type areas is comprised of at least one of: a hot data type area, a warm data type area, and a cold data type area.

4. The method of claim 3, wherein the cold data type area is used for storing less frequently updated data.

5. The method of claim 3, wherein the hot data type area is used for storing frequently updated data.

6. The method of claim 3, wherein the warm data type area is used for storing updates to the cold data type area.

7. The method of claim 4, wherein the cold data type area is comprised of large extents.

8. The method of claim 4, wherein the warm data type area is comprised of small extents.

9. The method of claim 1, wherein log comprises a fixed size log.

10. The method of claim 1, wherein the log comprises at least one of: a header and a footer.

11. The method of claim 1, further comprising:
instantiating a garbage collection subsystem;
identifying, using the garbage collection subsystem, a cold data type area of the plurality of data type areas; and
reclaiming space of the cold data type area using the garbage collection subsystem.

12. The method of claim 11, wherein the garbage collection is performed on oldest data of the cold data type area first.

13. A computer program product comprised of a series of instructions executable on a computer, the computer program product performing a process for improving flash-oriented file system garbage collection, the computer program implementing the steps of:
classifying data according to a first data type area of a plurality of data type areas;
creating, using a host device subsystem, a log for a physical erase block of the flash memory;
creating, using the host device subsystem, the plurality of data type areas for the log; and
writing the data to the first data type area of the plurality of data type areas based on the classification of the data.

14. A system for improving flash-oriented file system garbage collection, the system comprising:
a storage media device;
a host device associated with the storage media device, wherein the host device is configured to:
classify data according to a first data type area of a plurality of data type areas;
create a log for a physical erase block of the storage media device;
create the plurality of data type areas for the log; and
write the data to the first data type area of the plurality of data type areas based on the classification of the data.

15. The system of claim 14, wherein the first data type area is based on an update frequency of data in a particular area.

16. The system of claim 15, wherein each of the plurality of data type areas is comprised of at least one of: a hot data type area, a warm data type area, and a cold data type area.

17. The system of claim 16, wherein the cold data type area is used for storing less frequently updated data.

18. The system of claim 16, wherein the hot data type area is used for storing frequently updated data.

19. The system of claim 16, wherein the warm data type area is used for storing updates to a cold data type area.

20. The system of claim 16, wherein the cold data type area is comprised of large extents.
